(19) United States
(12) Patent Application Publication
(10) Pub. No.: US 2008/0249792 A1
(43) Pub. Date: Oct. 9, 2008

(54) System and method for providing professional services

(76) Inventor: J. Christopher Robertson, Houston, TX (US)

Correspondence Address: ALBERTO Q. AMATONG, JR., P.O. BOX 70889, HOUSTON, TX, 77270-0889, US

(21) Appl. No.: 11/784,043

(22) Filed: Apr. 5, 2007

(51) Int. Cl. G06Q 10/00

(52) U.S. Cl. 705/1

(57) ABSTRACT

A method and system for providing personal services to a customer on a recurring basis. In one embodiment, upon first providing personals services to achieve a desired result for the customer, a customer record is created containing objective and subjective data associated with the provision of services to the customer. Upon a subsequent visit to a service location, a customer's record can be retrieved and referred to by the service provider in order to ensure consistency in the result of the services provided to the customer from visit to visit. In an exemplary embodiment, the method and system are utilized by a plurality of hair styling businesses, each of which having access to a central database of customer records, thus enabling a customer to patronize any of the plurality of businesses while being assured of a measure of consistency in the result of the services provided.

### FIELD OF THE INVENTION

The present invention relates to the providing of personal services to clients, and more particularly relates to a system and method for providing services on a repeating basis.

### BACKGROUND OF THE INVENTION

There are numerous types of businesses which involve the providing of personal services to clients. An illustrative example (by no means the only one to which the present invention may be advantageously applied, as will hereinafter become apparent), is the business of hairstyling. The beauty industry in the United States presently represents a US $135 billion market; one of the larger hair salon entities in the U.S. presently has upwards of 10,000 company-owned or franchised locations. There are countless privately-owned hair styling salons located throughout the country.

One perceived deficiency in the hairstyling and other personal service provider industries is the potential for lack of consistency in the quality and style of the services provided to a given client from one visit to the next. In the case of hair styling, for example, a customer who visits a particular service location at a particular time often times will be assigned to a stylist on a more or less random basis. In such situations, the stylist will likely be unaware of the customer's preferences as to the nature and style of the services to be performed, and may have no way of knowing whether the customer has visited the particular location in the past. This can lead to inconsistencies in the services provided to the customer from visit to visit.

For the most part, problems with inconsistent service to a customer are dealt with through the informal process of the hairstylist asking the customer some questions about his or her preferences and then attempting to interpret the customer's responses as best as possible to achieve the desired result. The ad hoc nature of this process still leaves open the possibility for significant variation in results from visit to visit, and can leave the customer less than fully satisfied. Moreover, customers often have difficulty in expressing their preferences in terms that will be meaningful and understandable to the hairstylist.

Problems with inconsistency of service can also be addressed to some degree in cases where it is possible for the customer to schedule an appointment with a given hairstylist, at a given location, at a given time, each time the customer wishes to have his or her hair styled. This too is a less than ideal solution, as it adds to the inconvenience to the customer in pre-arranging for the service, and places the customer at the mercy of the desired hairstylist's availability at a convenient time. Often, customers may decide only at the last minute that they wish to receive the services of the hairstylist, and there can be no guarantee that the desired hairstylist will be available at that time. Additionally, there is no guarantee that a particular hairstylist may remain employed at a particular location indefinitely. Furthermore, even if a mutually convenient appointment can be made for a customer to be serviced by the hairstylist of his or her choosing, this arrangement requires the hairstylist to remember each of his or her repeat customer's personal preferences, which may be impractical at service locations which experience large volumes of business.

A further problem arises when it becomes necessary for a customer to visit a different location when services are desired. For example, many business persons travel away from home frequently and/or for lengthy periods of time, making it impossible for the customer to arrange to receive service from the same provider as in previous visits.

Thus, there is believed to be a need for improvement in consistency in the rendition of personal services for customers that remains unmet by current industry practices.

### SUMMARY OF THE INVENTION

In view of the foregoing, the present invention is directed to a system and method for increasing the consistency of services provided to a customer from one visit to the next, and/or from one location to another.

In accordance with one aspect of the invention, a system and method is provided involving the maintenance of a customer tracking database containing customer-specific information relating to the nature and style of services provided to customers by a service provider such as a hairstylist. In one embodiment, the system includes at least one computer for maintaining a customer database, where the database includes, for each customer, a customer record containing data corresponding to both subjective and objective information about the services that have been provided to that customer in the past.

### BRIEF DESCRIPTION OF THE DRAWINGS

The foregoing and other features and aspects of the present invention will be best appreciated by reference to a detailed description of specific embodiments of the invention, when read in conjunction with the accompanying drawings, wherein:

FIG. 1 is a flow diagram illustrating a method of providing services in accordance with one embodiment of the invention;

FIG. 2 depicts a customer record maintained in a database in accordance with one embodiment of the invention; and

FIG. 3 depicts a system including a plurality of service locations interconnected by a network, each service location being capable of executing the method depicted in FIG. 1.

### DETAILED DESCRIPTION OF SPECIFIC EMBODIMENTS OF THE INVENTION

In the disclosure that follows, in the interest of clarity, not all features of actual implementations are described. It will of course be appreciated that in the development of any such actual implementation, as in any such project, numerous engineering and technical decisions must be made to achieve the developers' specific goals and subgoals (e.g., compliance with system and technical constraints), which will vary from one implementation to another. Moreover, attention will necessarily be paid to proper engineering and programming practices for the environment in question. It will be appreciated that such a development effort might be complex and time-consuming, but would nevertheless be a routine undertaking for those of ordinary skill in the relevant fields.

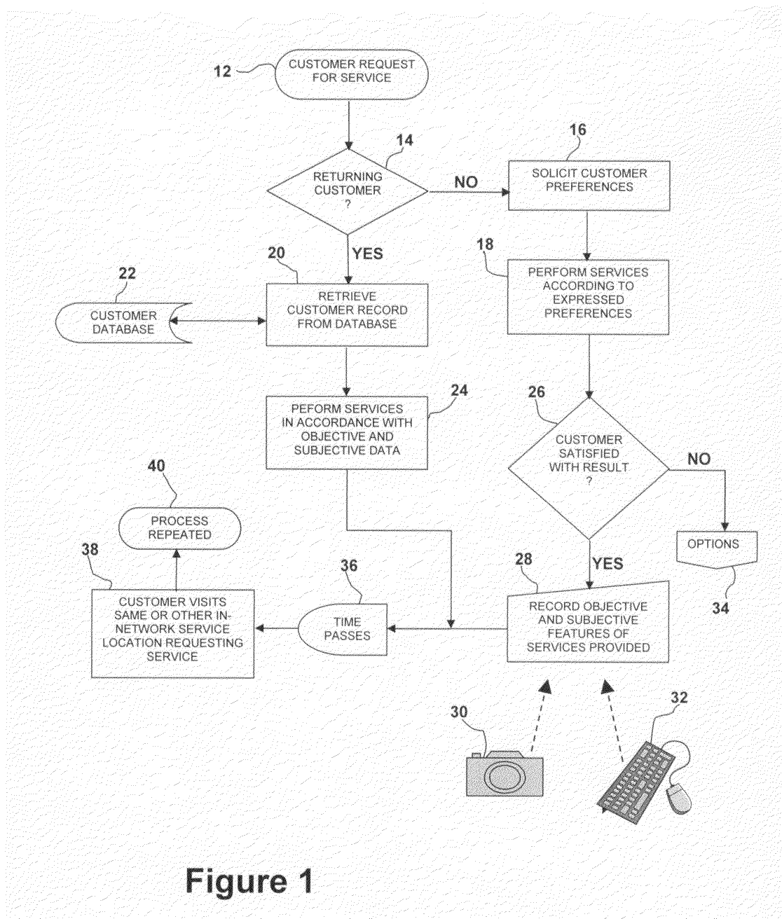

Referring to FIG. 1, there is shown a flow diagram illustrating a method of providing professional/personal services to customers in accordance with a presently preferred embodiment of the invention. In the description that follows, the application of the invention to the provision of hairstyling services will be utilized as an exemplary embodiment. However, those of ordinary skill in the art having the benefit of the present invention will readily appreciate that the invention is in no sense limited to hairstyling services, and may be advantageously implemented in numerous other professional/personal services contexts, such as, by way of example but not limitation, manicure services and tailoring services.

Referring to FIG. 1, the process begins, at block 12, with a customer requesting personal services from a service provider. As noted, it is believed that a variety of different service industries may make beneficial use of the present invention, as will be hereinafter be apparent to those of ordinary skill in the art having the benefit of the present invention. Assume for the sake of the exemplary embodiment, however, that the services in question involves hairstyling.

Upon arrival at the service location, it is to be ascertained whether the customer has previously patronized the location (or any “in-network” location, as will be hereinafter described in further detail), as represented by block 14.

Of course, one possibility is that the customer has not previously patronized the establishment, in which case, in a conventional manner, it would be necessary for the service provider to solicit from the customer instructions as to the customer's preferences as to the nature and style of the services to be performed. In the case of hairstyling, this would involve asking the customer a series of questions relating to the type of hairstyle desired (length, style, coloring, and so on), as represented by block 16 in FIG. 1.

Once the service provider has sufficient information as to the customer's preferences, the provider can commence providing the requested service, as shown at block 18.

As thus far described, the customer's experience is essentially the same as would be in a conventional setting, with the results of the services being performed being largely dependent upon the customer's ability to accurately relate to the service provider his or her service preferences.

In accordance with one aspect of the invention, and as represented by block 26 in FIG. 1, the present invention then calls for the service provider to inquire whether the customer is satisfied with the result of the service rendered. In cases where the customer indicates satisfaction with the result, and in accordance with one aspect of the invention, the service provider can offer to create a customer record, as reflected by box 28 in FIG. 1. In accordance with one embodiment of the invention, a customer record is a set of data characterizing both objective and subjective features of the service provided to the customer.

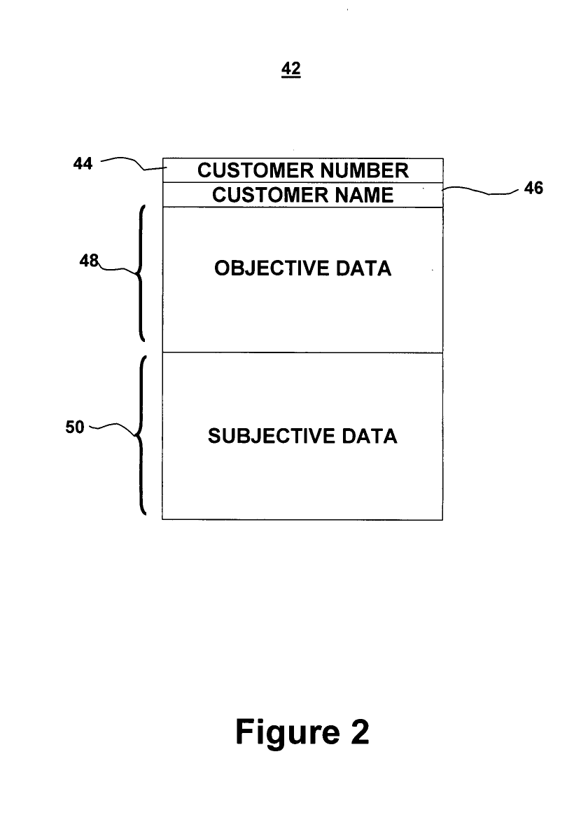

A sample customer record 42 is shown in FIG. 2. As shown in FIG. 2, a customer record 42 preferably includes identifying information about the customer, including, for example, a customer number 44, and/or a customer name 46. Furthermore, and in accordance with one aspect of the invention, a customer record includes objective data 46 relating to the service provided to the customer. Such 11 objective data 46 may comprise various types of information about the service that can be objectively described or quantified. In the case of hairstyling, for example, such objective data can include such information as hair length at various locations on the customer's head, clipper types and sizes used, and/or dye colors.

In a preferred embodiment, the customer record is created using a conventional computer and the objective data is entered by a user using conventional user input devices, such as a keyboard 32 as shown in FIG. 1. It is believed that the programming of a computer system to achieve the functionality of creating a customer record and maintaining a customer database (as will be hereinafter described in further detail) would be a matter of routine computer programming readily accomplished by those of ordinary skill in the art. The particulars relating to the computer programming necessary to achieve the functionality described herein may vary from implementation to implementation, and it is believed that the details of such programming need not be set forth herein in order to provide a thorough understanding of the invention.

With continued reference to FIG. 1, and in accordance with another important aspect of the invention, the step 28 of creating a customer record 42 further involves including in the customer record 42 certain subjective data 50 relating to the result achieved through provision of the service to the customer. In one embodiment of the invention, the subjective data 50 in customer record 42 consists of one or more digitized photographic images of the result of the service. In the exemplary case of hairstyling, the subjective data 50 may consist of one or more digital photographs of the customer's hairstyle following performance of the hairstyling services. For example, the hairstylist may take front, side, and back views of the customer using a digital camera 30, in order to provide a complete record of the result of the hairstyling.

Once the customer record 42 is created, and in accordance with still another aspect of the invention, it is stored in a customer database 22 for later retrieval, as will be hereinafter described.

Creation of customer record 42 essentially concludes the service providing process for the customer on a particular visit to the service location. As previously noted, the present invention is especially advantageous in the context of services that a customer will require on a recurring, periodic basis, meaning that some time will pass between customer visits to a service location such as a hair salon. This is represented by block 36 in FIG. 1. After some amount of time has passed, for the purposes of the present disclosure it is assumed that the customer will return to the service location, as represented by block 38 in FIG. 1. At this time, the process depicted in FIG. 1 is then repeated.

Upon a return visit to the service location (or another “in-network” location, as will be hereinafter described), the inquiry represented by block 14 in FIG. 1 will be answered in the affirmative, leading to step 20 in FIG. 1, which involves retrieval of the customer's record 42 from customer database 22. This gives the service provider valuable information about the customer's preferences regarding the service to be provided, and lessens the likelihood that the customer might be unable to effectively communicate his or her preferences to the provider. The subjective data contained in the customer record 42 in particular provides information to the service provider that would not otherwise be available but for the practice of the present invention.

Thus, the service provider can perform the service in accordance with the data contained in the customer record 42, as represented by block 24 in FIG. 1, with a significantly greater likelihood that the result desired by the customer will be achieved. That is, the service performed in block 24 is likely to achieve a result that is highly consistent with results previous achieved for the customer.

It is to be noted that in accordance with one beneficial aspect of the invention, it is not necessary for the service provided in block 24 to be performed by the same service provider as the one who provided the services in block 18 upon the customer's initial visit, while at the same time, the same, desired result can be consistently achieved in both instances.

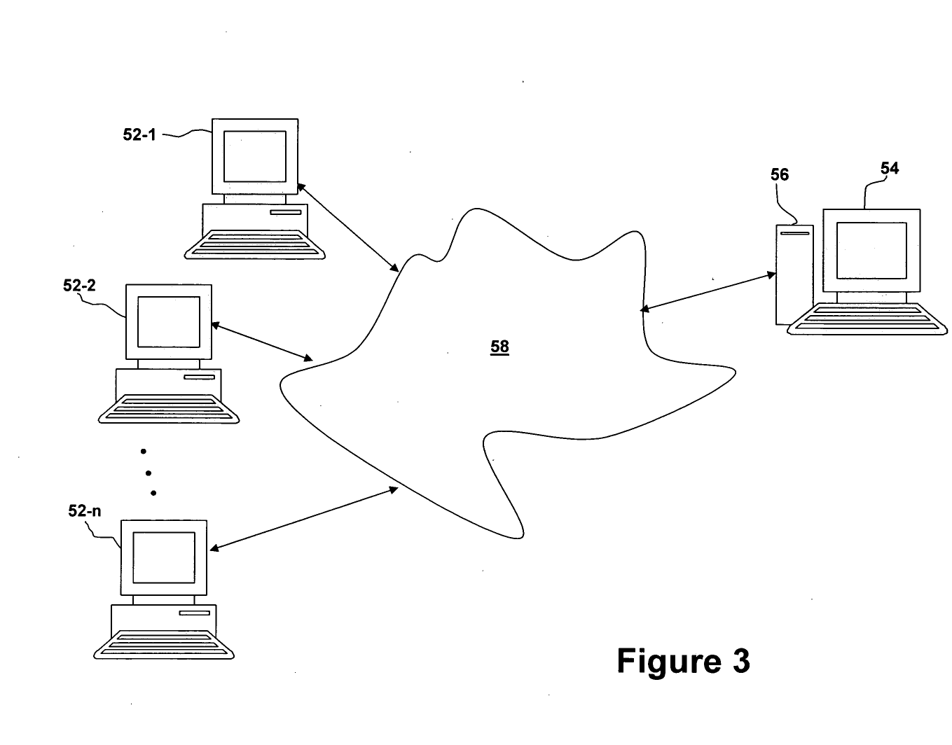

As has been alluded to above, the present invention offers additional benefits to service providers who provider their services at a plurality of different locations. One example would be hair styling chains which have service locations located throughout the United States, as would be familiar to most people. FIG. 3 is a simplified diagram useful for illustrating this advantageous aspect of the invention. Shown in FIG. 3 are a plurality of computers 52-1, 52-2 . . . 52-n (collectively referred to as computers 52) which for the purposes of the exemplary embodiment are assumed to be located at service locations at geographically different locations.

Also shown in FIG. 3 is a central server 54 having a processing unit 56 with mass storage for maintaining customer database 22 of customer records. In the exemplary embodiment, computers 52 and server 54 are interconnected by means of a network 58. Those of ordinary skill in the art will appreciate that network 58 may comprise any of the well-known means of facilitating interconnection of a plurality of computers, including, without limitation, local area networks (LANs), wide area networks (WANs), or, preferably, the Internet, which is well known by those of ordinary skill in the art to comprise a global interconnection of computers, networks, WANs, LANs, and other devices.

In accordance with one aspect of the invention, each computer 52 in FIG. 3 is programmed to execute the process depicted in FIG. 1 at a service provider location, and by virtue of interconnection via network 58, has access to customer database 22. Computers 52 are thus considered to be “in network” with respect to the system of the present invention.

Having the benefit of FIG. 3, those of ordinary skill in the art will recognize that the present invention can be advantageously practiced in such a manner that a customer can visit any in-network service location having a computer 52 and benefit from the ability of each in-network service provider to access and retrieve customer records from database 22. In this way, a customer can be assured of receiving consistent service from any in-network service provider it may be wherever located. This can be of great benefit, for example, to persons who travel, or to persons who relocate, or to persons who simply decide to patronize one service provider rather than another.

From the foregoing, it should be apparent that a system and method for providing consistent personal services to customers patronizing service providers on a recurring or occasional basis has been disclosed. Although specific embodiments and design alternatives have been described herein in some detail, it is to be understood that this has been done solely to illustrate various aspects of the invention, and is not intended to be limiting with respect to the scope of the invention. It is contemplated that various substitutions, alterations, and/or modifications to the embodiments disclosed herein, including but not limited to those specific implementation variations and options that may have been specifically noted herein, may be made without departing from the spirit and scope of the invention as defined in the appended claims, which follow.

What is claimed is:

1. A method of providing personal services to a customer on a plurality of successive occasions, comprising:
providing said personal services to said customer, said personal services achieving a result characterized by at least one objective feature and at least one subjective feature;
verifying said customer's satisfaction with said result;
creating and storing a customer record containing data corresponding to said at least one objective feature and data corresponding to said at least one subjective feature;
upon any subsequent request for personal services by said customer, retrieving said customer record and providing said personal services to said customer based on said data.

2. A method in accordance with claim 1, wherein said personal services comprise hairstyling services.

3. A method in accordance with claim 2, wherein said at least one objective feature comprises a quantifiable parameter of said hairstyling services.

4. A method in accordance with claim 3, wherein said quantifiable parameter comprises hair length at a specified location on said customer.

5. A method in accordance with claim 2, wherein said at least one subjective feature comprises overall appearance of said customer's hair following provision of said hairstyling services.

6. A method in accordance with claim 5, wherein said data corresponding to said at least one subjective feature comprises at least one photograph of said customer's hairstyle following provision of said personal services.

7. A method in accordance with claim 1, further comprising:
maintaining a database of said customer records.

8. A method in accordance with claim 7, wherein said database of said customer records is maintained on a central server.

9. A method in accordance with claim 8, wherein said personal services are provided by a service provider located at a fixed location.

10. A method in accordance with claim 9, wherein said fixed location is remotely located from said central server and said service provider accesses said database via a computer network.

11. A system for providing personal services to a customer on a plurality of successive occasions, wherein said personal services achieve a desired result characterized by at least one objective feature and at least one subjective feature, comprising:
a data storage mechanism for storing a plurality of customer records, wherein each customer storage record includes data corresponding to said at least one objective feature of said desired result and to said at least one subjective feature of said desired result for a specific customer for whom said personal services have been provided;
a data retrieval mechanism for retrieving a customer record from said data storage mechanism for a customer requesting said personal services, such that said personal services are performed based on said data corresponding to said at least one objective feature and said data corresponding to said at least one subjective feature.

12. A system in accordance with claim 11, wherein said personal services comprise hairstyling services.

13. A system in accordance with claim 12, wherein said at least one subjective feature comprises the overall appearance of a customer's hairstyle.

14. A system in accordance with claim 13, wherein said data corresponding to said at least one subjective feature comprises at least one photograph of a customer's hairstyle.

15. A system in accordance with claim 11, wherein said data storage mechanism comprises a computer equipped with a mass storage device.

16. A system in accordance with claim 11, wherein said data retrieval mechanism comprises a computer coupled to said mass storage device.

17. A system in accordance with claim 16, wherein said data retrieval mechanism is coupled to said mass storage device via a computer network.

18. A system in accordance with claim 17, wherein said computer network comprises a wide-area network.

19. A system in accordance with claim 17, wherein said computer network comprises the Internet.
